(19) United States
(12) Patent Application Publication
(10) Pub. No.: US 2025/0379447 A1
(43) Pub. Date: Dec. 11, 2025

(54) SOLAR POWER GENERATION SYSTEM

(71) Applicant: TOYOTA JIDOSHA KABUSHIKI KAISHA, Toyota-shi (JP)

(72) Inventor: Takuya YASUI, Miyoshi-shi (JP)

(73) Assignee: TOYOTA JIDOSHA KABUSHIKI KAISHA, Toyota-shi (JP)

(21) Appl. No.: 19/024,303

(22) Filed: Jan. 16, 2025

(30) Foreign Application Priority Data
Jun. 10, 2024 (JP) 2024-093534

(51) Int. Cl. H02J 3/38; H02S 10/00

(52) U.S. Cl. CPC H02J 3/38; H02S 10/00; H02J 2300/26

(57) ABSTRACT

A solar power generation system configured by connecting a plurality of power generation systems including a solar panel and a DCDC circuit unit in parallel includes a first control unit that performs maximum power point tracking control for a host power generation system that is one of the power generation systems, and drives the DCDC circuit unit at a duty cycle corresponding to a maximum power point of the solar panel, and a second control unit that, for each of slave power generation systems other than the host power generation system among the power generation systems, derives a variation ratio of an input voltage or an output voltage of the DCDC circuit unit before and after the maximum power point tracking control is performed by the first control unit, and corrects the duty cycle of the DCDC circuit unit based on the variation ratio.

### CROSS-REFERENCE TO RELATED APPLICATION

This application claims priority to Japanese Patent Application No. 2024-093534 filed on Jun. 10, 2024, incorporated herein by reference in its entirety.

### BACKGROUND

### 1. Technical Field

The present disclosure relates to a solar power generation system employing a configuration in which a plurality of solar panels is connected in parallel.

### 2. Description of Related Art

Japanese Unexamined Patent Application Publication No. 2020-141545 (JP 2020-141545 A) discloses a solar power generation system employing a configuration in which a plurality of solar panels is connected in parallel. In this solar power generation system, an overlap of periods in which maximum power point tracking (MPPT) control is performed for each solar panel is reduced. JP 2020-141545 A describes a method in which the power generation efficiency of the solar power generation system as a whole is thus improved.

### SUMMARY

In the solar power generation system in which a plurality of solar panels is connected in parallel, it is conceivable to perform the MPPT control independently and sequentially one by one for the solar panels in order to avoid the overlap of the periods in which the MPPT control is performed.

In this method, however, the configuration of the solar power generation system may be a configuration in which the output sides of a plurality of DCDC converters that performs the MPPT control for the solar panels are electrically connected directly to a battery or the like. In this case, when the output-side current and voltage common to the DCDC converters fluctuate due to the MPPT control performed by the DCDC converter for any one of the solar panels, the input-side voltages of the other DCDC converters that do not perform the MPPT control are affected. Such an effect is caused by a harness wiring resistance between devices, a pattern resistance in an electronic control unit (ECU) for controlling solar power generation, a charge current-voltage characteristic of the battery, or the like.

When the input voltages from the solar panels connected to the other DCDC converters unexpectedly fluctuate due to the fluctuations in the output-side current and voltage common to the DCDC converters, the operating points of the solar panels deviate from the maximum power points and the power generation efficiency decreases. Such a decrease in power generation efficiency is more conspicuous because, as the number of solar panels connected in parallel increases, the timing at which the operating point can be corrected becomes later (the control execution interval increases) and the operating period with low efficiency increases. For this reason, the solar power generation system in which the MPPT control is performed sequentially one by one for the solar panels has room for further study on the method for performing the MPPT control.

The present disclosure has been made in view of the above issue, and an object of the present disclosure is to provide a solar power generation system capable of suppressing deviation of an operating point of each solar panel from a maximum power point when MPPT control is performed sequentially one by one for a plurality of solar panels connected in parallel.

In order to solve the above issue, an aspect of the technology of the present disclosure is a solar power generation system including a plurality of power generation systems connected in parallel. The power generation systems each include a solar panel and a direct current-to-direct current circuit unit configured to control an operating point of power generation of the solar panel according to a duty cycle of a drive signal of a direct current-to-direct current converter. The solar power generation system includes:
a first control unit configured to perform maximum power point tracking control for a host power generation system that is one of the power generation systems, and drive the direct current-to-direct current circuit unit at the duty cycle corresponding to a maximum power point of the solar panel; and
a second control unit configured to, for each of slave power generation systems other than the host power generation system among the power generation systems, derive a variation ratio of an input voltage or an output voltage of the direct current-to-direct current circuit unit before and after the maximum power point tracking control is performed by the first control unit, and correct the duty cycle of the direct current-to-direct current circuit unit based on the variation ratio.

With the solar power generation system of the present disclosure, it is possible to suppress the deviation of the operating point of each solar panel from the maximum power point. Thus, it is possible to reduce a decrease in power generation efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a solar power generation system according to an embodiment of the present disclosure;

FIG. 2A is a process flow chart of solar power generation control performed by the solar power generation system; and

FIG. 2B is a process flow chart of solar power generation control performed by the solar power generation system.

### DETAILED DESCRIPTION OF EMBODIMENTS

In the solar power generation system of the present disclosure, when MPPT control of the respective systems is sequentially performed one by one in a configuration in which a plurality of systems for generating electric power by the solar panel are connected in parallel, nothing is done until the order of MPPT control of the own system comes. In the solar power generation system of the present disclosure, the operating point of the solar panel of the own system is corrected at any time so as not to deviate from the maximum power point based on MPPT control performed by the other system. This reduces the reduction in the power generation efficiency of the system.

Hereinafter, an embodiment of the present disclosure will be described in detail with reference to the drawings.

### Embodiment

### Configuration

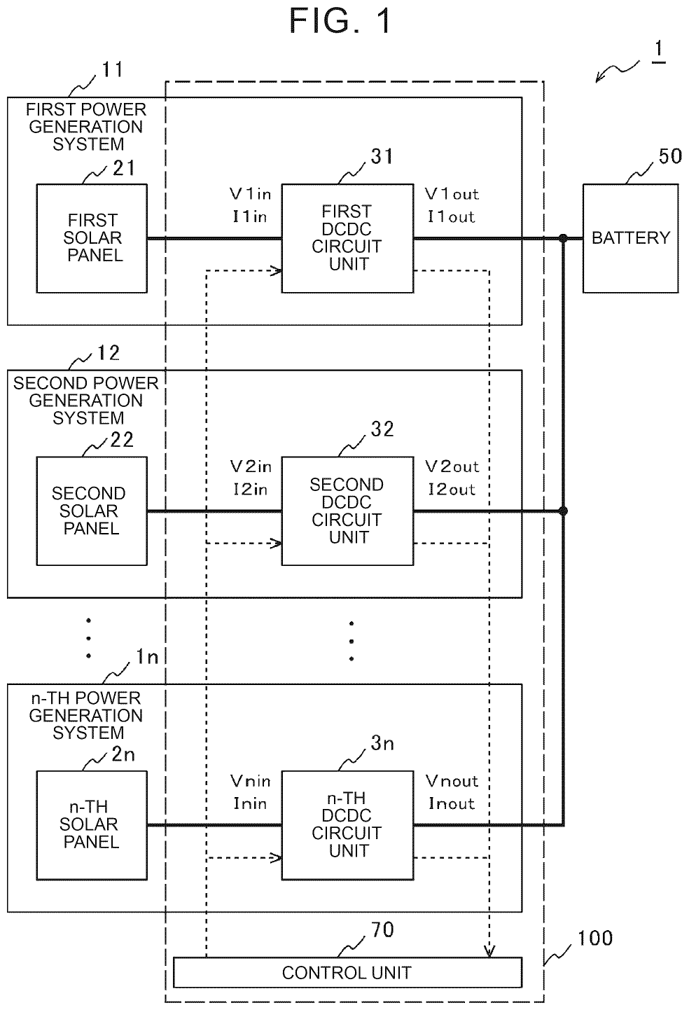

FIG. 1 is a block diagram illustrating a schematic configuration of a solar power generation system 1 according to an embodiment of the present disclosure. The solar power generation system 1 illustrated in FIG. 1 includes a first power generation system 11 as a plurality of power generation systems, an n-th power generation system In (n is an integer of 3 or more) from the second power generation system 12, a battery 50, and a control unit 70. In FIG. 1, a wiring through which electric power flows is indicated by a thick solid line, and a wiring through which a measurement value, a control signal, or the like flows is indicated by a dotted line.

The solar power generation system 1 can be mounted on vehicles such as, for example, hybrid electric vehicle (HEV), plug-in hybrid electric vehicle (PHEV), and battery electric vehicle (BEV).

The first power generation system 11 includes a first solar panel 21 and a first DCDC circuit unit 31. The first solar panel 21 is a solar cell module that generates electric power by being irradiated with sunlight. The first solar panel 21 is connected to the first DCDC circuit unit 31, and the electric power generated by the first solar panel 21 is outputted to the first DCDC circuit unit 31. The first DCDC circuit unit 31 is configured to be able to individually control the power generated by the first solar panel 21. More specifically, the first DCDC circuit unit 31 includes DCDC converters (not shown). The first DCDC circuit unit 31 boosts or lowers the voltage in accordance with a change in the duty cycle of the drive signal of DCDC converter based on an instruction from the control unit 70. Accordingly, the first DCDC circuit unit 31 can perform MPPT control for searching for an operating point, that is, a maximum power point, at which the power generation efficiency of the first solar panel 21 is maximized. In this MPPT control, a well-known technique called a so-called hill-climbing method can be used. The output of the first DCDC circuit unit 31 is output to the battery 50.

The first power generation system 11 also includes a sensor (not shown) for acquiring information regarding the power generation state of the first solar panel 21. The first DCDC circuit unit 31 acquires the voltage V1in and the current I1in inputted from the first solar panel 21 and the voltage V1out and the current I1out outputted from the first DCDC circuit unit 31 to the battery 50 at least as data. Each piece of information acquired by the sensor is output to the control unit 70.

The second power generation system 12 includes a second solar panel 22 and a second DCDC circuit unit 32. Like the first solar panel 21, the second solar panel 22 is a solar cell module that generates electric power by being irradiated with sunlight. The second solar panel 22 is connected to the second DCDC circuit unit 32, and the electric power generated by the second solar panel 22 is outputted to the second DCDC circuit unit 32. The second DCDC circuit unit 32 is configured to individually control the power generated by the second solar panel 22. More specifically, the second DCDC circuit unit 32 includes DCDC converters (not shown) as well as the first DCDC circuit unit 31. The second DCDC circuit unit 32 boosts or lowers the voltage in accordance with a change in the duty cycle of the drive signal of DCDC converter based on an instruction from the control unit 70. This allows the second DCDC circuit unit 32 to perform MPPT control to search for the highest power point of the second solar panel 22. An output of the second DCDC circuit unit 32 is connected in parallel with an output of the first DCDC circuit unit 31, and is output to the battery 50.

The second power generation system 12 also includes a sensor (not shown) for acquiring information regarding the power generation state of the second solar panel 22. The second DCDC circuit unit 32 acquires the voltage V2in and the current I2in inputted from the second solar panel 22 and the voltage V2out and the current I2out outputted from the second DCDC circuit unit 32 to the battery 50 at least as data. Each piece of information acquired by the sensor is output to the control unit 70.

The configurations from the third power generation system 13 to the n-th power generation system In are the same as those of the first power generation system 11 and the second power generation system 12 described above, and therefore, their explanations are omitted. Note that the first solar panel 21, the second solar panel 22 to the n-th solar panel 2n may all have the same performance, capacitance, dimensions, shapes, and the like, or may be partially or entirely different. Further, the first DCDC circuit unit 31, 30 the second DCDC circuit unit 32 to the n-th DCDC circuit unit 3n may be the same in all the types, functions, and performances of step-up and step-down, or may be partially or entirely different from each other.

The battery 50 is a secondary battery configured to be chargeable and dischargeable, such as a lithium-ion battery. The battery 50 is connected to the respective outputs of the first DCDC circuit unit 31, the second DCDC circuit unit 32, and the n-th DCDC circuit unit 3n. The battery 50 is configured to receive electric power from the n-th power generation system In from the first power generation system 11 and the second power generation system 12. When the solar power generation system 1 is mounted on a vehicle, the battery 50 may be an auxiliary battery. The battery 50 may be connected to a device or the like (auxiliary load) that operates by receiving power from the battery 50.

The control unit 70 controls the n-th DCDC circuit unit 3n from the first DCDC circuit unit 31 and the second DCDC circuit unit 32. The control unit 70 may control the generated electric power of the first solar panel 21 and the n-th solar panel 2n from the second solar panel 22. Specifically, the control unit 70 acquires Inout from the first power generation system 11, the second power generation system 12 to the n-th power generation system In, from the input voltage V1in, V2in, from Vnin, from the input current I1in, I2in, from Inin, from the output voltage V1out, V2out to Vnout, and from the output current I1out, I2out. The control unit 70 appropriately controls the duty cycle of the drive signal of DCDC converter, which is the instruction value given to the n-th DCDC circuit unit 3n from the first DCDC circuit unit 31 and the second DCDC circuit unit 32, based on these pieces of information. The control executed by the control unit 70 will be described later.

All or a portion of the control unit 70 described above may typically be configured as an electronic control unit (ECU) including a processor, such as a CPU, memories, and input/output interfaces. For example, the control unit 70 serving as a CPU and the n-th DCDC circuit unit 3n from the first DCDC circuit unit 31 and the second DCDC circuit unit 32 can be configured as a single solar control ECU 100. In such an electronic control unit, a predetermined function is realized by a processor reading and executing a program stored in a memory.

### Control

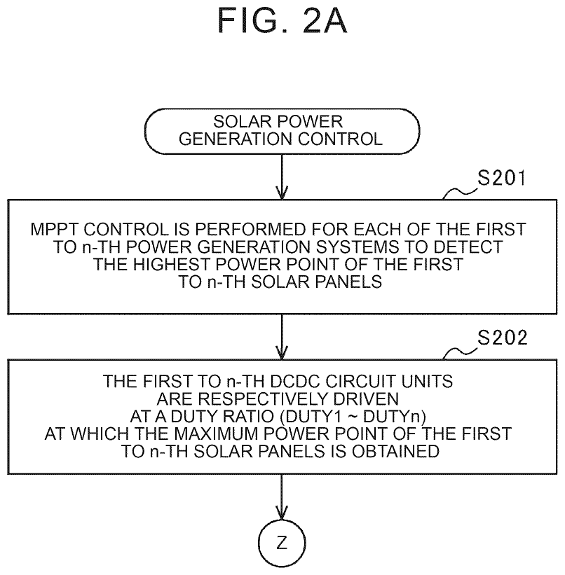

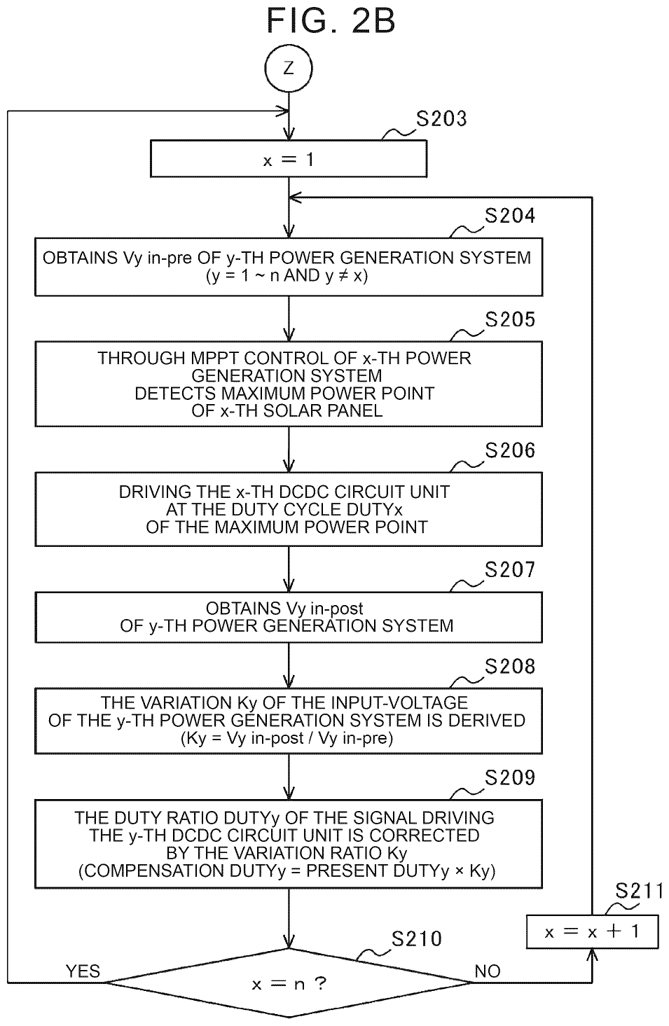

Next, the control performed by the solar power generation system 1 according to an embodiment of the present disclosure will be described with reference to FIGS. 2A and 2B. FIGS. 2A and 2B are flow charts showing the steps of the solar power generation control executed by the control unit 70 of the solar power generation system 1. The process of FIG. 2A and the process of FIG. 2B are connected by the coupler Z.

The solar power generation control illustrated in FIGS. 2A and 2B is started, for example, when the solar power generation system 1 is activated (wake-up), and ends when the solar power generation system 1 is stopped (sleep). That is, the solar power generation control is repeatedly executed during the operation period of the solar power generation system 1. In the following solar power generation control, DCDC circuit unit includes step-down DCDC converters that satisfy the I/O relation of “input voltage x duty ratio =output voltage”.

### S201

The control unit 70 performs MPPT control for each of the first power generation system 11 and the n-th power generation system In from the second power generation system 12, and detects the highest power point of the first solar panel 21 and the n-th solar panel 2n from the second solar panel 22. That is, the control unit 70 performs MPPT control of the first power generation system 11 to detect an initial-value of the maximum power point of the first solar panel 21. Then, the control unit 70 performs MPPT control of the second power generation system 12 to detect an initial-value of the maximum power point of the second solar panel 22. This process is repeated from the third to n-th times, and the control unit 70 performs MPPT control of the n-th power generation system In to detect an initial-value of the maximum power point of the n-th solar panel 2n. While MPPT control of one power generation system is being performed, all the operations of the other power generation systems may be stopped (without outputting DCDC circuit unit), or the operations of only the power generation systems whose MPPT control is not performed among the other power generation systems may be stopped.

When the control unit 70 detects the highest power point of the n-th solar panel 2n from the first solar panel 21 and the second solar panel 22, the process proceeds to S202.

### S202

The control unit 70 drives the first DCDC circuit unit 31 and the n-th DCDC circuit unit 3n from the second DCDC circuit unit 32 at an operating point at which the power of each solar panel becomes the maximum power, based on the maximum power points of the first solar panel 21 detected by S201 and the n-th solar panel 2n from the second solar panel 22. That is, the control unit 70 drives the first DCDC circuit unit 31 at the duty cycle DUTY1 at which the highest power point of the first solar panel 21 is obtained. The control unit 70 drives the second DCDC circuit unit 32 at a duty cycle DUTY2 at which the maximum power point of the second solar panel 22 is obtained. Similarly, from the second to n-th, the control unit 70 drives the n-th DCDC circuit unit 3n at the duty cycle DUTYn at which the highest power point of the n-th solar-panel 2n is obtained.

The control unit 70 drives the first DCDC circuit unit 31 and the n-th DCDC circuit unit 3n from the second DCDC circuit unit 32 at a duty cycle at which the highest power point of the n-th solar panel 2n is obtained from the first solar panel 21 and the second solar panel 22. Thereafter, the process proceeds to S203.

### S203

The control unit 70 sets the value of the variable x to “1” (x=an integer from 1 to n). The variable x is a variable for specifying a power generation system (a host-power generation system) that performs MPPT control. By setting this S203, a target for performing MPPT control is designated as the first power generation system 11.

When “1” is set to the variable x by the control unit 70, the process proceeds to S204.

### S204

The control unit 70 acquires the input voltages of DCDC circuit unit for all the power generation systems (slave power generation systems) that do not perform MPPT control prior to performing MPPT control on the x-th power generation system 1x (second control unit). That is, the control unit 70 acquires the input-voltage Vyin of the y-th DCDC circuit unit 3y for all the y-th power generation system 1y (y=1 to n integers and y≠x) except for the x-th power generation system 1x among the first power generation system 11 to the n-th power generation system In. Since the input voltage Vyin acquired here is the voltage prior to the execution of MPPT control, it is distinguished from the input voltage Vyin-pre.

When the control unit 70 acquires the input-voltage Vyin-pre of the y-th DCDC circuit unit 3y, the process proceeds to S205.

### S205

The control unit 70 performs MPPT control on the x-th power generation system 1× to detect the highest power point of the x-th solar-panel 2x (first control unit). This process is the same as the process performed in the above S201.

When the maximum power point of the x-th solar-panel 2x is detected by the control unit 70, the process proceeds to S206.

### S206

Based on the maximum power point of the x-th solar panel 2x detected by S205, the control unit 70 drives the x-th DCDC circuit unit 3x at the duty cycle DUTYx at which the maximum power point of the x-th solar panel 2x is obtained (first control unit). This process is the same as the process performed in the above S202.

When the x-th DCDC circuit unit 3x is driven by the control unit 70 at the duty cycle DUTYx at which the maximum power point of the x-th solar-panel 2x is obtained, the process proceeds to S207.

### S207

After performing MPPT control on the x-th power generation system 1x, the control unit 70 acquires the input voltages of DCDC circuit unit for all power generation systems (slave power generation systems) that do not perform MPPT control (second control unit). That is, the control unit 70 acquires the input-voltage Vyin of the y-th DCDC circuit unit 3y for all the y-th power generation system 1y (y=1 to n integers and y≠x) except for the x-th power generation system 1x among the first power generation system 11 to the n-th power generation system In. Since the input voltage Vyin acquired here is the voltage after MPPT control is performed, it is distinguished from the input voltage Vyin-post.

When the control unit 70 acquires the input-voltage Vyin-post of the y-th DCDC circuit unit 3y, the process proceeds to S208.

### S208

The control unit 70 derives the variation ratio Ky of the input-voltage Vyin for all the y-th power generation systems ly (second control unit). The variation ratio Ky is a variation ratio of the input-voltage Vyin before and after the execution of MPPT control for the x-th power generation system 1x, and can be obtained by [Expression 1] below.

$$Ky = Vyin - post / Vyin - pre \qquad [ Equation 1 ]$$

For example, when the target of MPPT control is the first power generation system 11 (x=1), the variation-ratio K2 of the second power generation system 12 that is the target of the non-execution of MPPT control is derived. Then, the variation ratio K3 of the third power generation system 13 is derived, and this is repeated, and the variation ratio Kn of the n-th power generation system In is derived (y=2 to n).

When the control unit 70 derives the variation ratio Ky in the y-th power generation system 1y, the process proceeds to S209.

### S209

The control unit 70 corrects the duty ratio DUTYy of the signal for driving the y-th DCDC circuit unit 3y for all the y-th power generation systems ly on the basis of the variation ratio Ky (second control unit). This correction is performed by multiplying the present duty ratio DUTYy by the variation ratio Ky as in [Equation 2] below.

$$Corrected DUTYy = present DUTYy \times Ky \qquad [ Equation 2 ]$$

For example, when the target of MPPT control is the first power generation system 11 (x=1), the duty ratio DUTY2 of the second power generation system 12 that is the target of non-implementation is corrected by the variation ratio K2. Then, the duty ratio DUTY3 of the third power generation system 13 is corrected by the variation ratio K3, and similarly, this is repeated, and the duty ratio DUTYn of the n-th power generation system In is corrected by the variation ratio Kn (y=2 to n).

When the control unit 70 corrects the duty ratio DUTYy of the y-th DCDC circuit unit 3y in the y-th power generation system ly by the variation ratio Ky, the process proceeds to S210.

### S210

The control unit 70 determines whether or not the variable x specifying the power generation system for performing MPPT control is “n”. This determination is made in order to determine whether or not MPPT control is performed one by one for each of the first power generation system 11 to the n-th power generation system In.

When the control unit 70 determines that the value of the variable x is “n” (S210, Yes), the process proceeds to S203, and the control target returns to the first power generation system 11, and MPPT control is performed again. On the other hand, if the control unit 70 determines that the variable x is not “n” (S210, No), the process proceeds to S211.

### S211

The control unit 70 increments the variable x that designates the power generation system in which MPPT control is performed by one.

When the control unit 70 increments the value of the variable x by one, the process proceeds to S204, and the control target moves to the next (x+1)-th power generation system 1(x+1) to perform MPPT control.

### Operations and Effects

As described above, when MPPT control of the plurality of solar panels connected in parallel is performed one by one, the current and the voltage of the common-output-side in the plurality of DCDC circuit unit parts may fluctuate due to MPPT control performed by one solar panel. Even in such cases, according to the solar power generation system according to an embodiment of the present disclosure, the operation of the other DCDC circuit unit is corrected so as to be able to cancel the effect that the input-side of the other DCDC circuit unit that is not performing MPPT control is affected. As a specific example of the correction control, the duty cycle of the signal for driving the other DCDC circuit unit is corrected.

By this correction control, it is possible to suppress deviation of the operating point of each solar panel from the maximum power point (to maintain the operating point at the maximum power point). Therefore, even if MPPT control is performed in any power generation system, it is possible to suppress a decrease in the power generation efficiency of the solar power generation system as a whole.

### First Modification

In the above-described embodiment, an example in which the corrected duty ratio DUTYy with respect to the y-th DCDC circuit unit 3y is obtained from the variation ratio Ky of the input-voltage Vyin has been described. However, the corrected duty ratio

DUTYy can be obtained from the variation ratio Ky of the output-voltage Vyout. In this case, in the flow chart of FIG. 2B, the correction control can be realized by replacing “Vyin-pre” with “Vyout-pre” and “Vyin-post” with “Vyout-post”, respectively, and replacing [Expression 2], which is calculated by S209, with [Expression 3] below.

$$Corrected DUTYy = present DUTYy \times ( 1 / Ky ) \qquad [ Equation 3 ]$$

### Second Modification

In the above-described embodiment, DCDC circuit unit includes the step-down DCDC converters that satisfy the I/O relation of “input voltage x duty ratio =output voltage”. However, in addition to this, DCDC circuit unit can also include step-up DCDC converters. For example, DCDC circuit unit of a power generation system may operate at an α-fold boost ratio (output/input) to allow the solar panels to operate at full power points. If the output-voltage is changed from mV to (m×β)V due to the effect of MPPT control of the other power generation system, the duty ratio is corrected so that the boost ratio of DCDC circuit unit is α×β times. This allows the solar panel to continue to operate at its full power point without any change in DCDC circuit unit.

In the case of this example, the duty ratio to be corrected may be obtained by calculation using a predetermined calculation formula, or may be obtained by extracting a value from a map created in advance. In the latter case, for example, if a two-dimensional map of the change correction amount of the duty ratio is prepared in advance by an experiment or the like based on the α value and the β value, the corrected duty ratio can be easily determined from the two-dimensional map.

Of course, as long as the duty cycle of the signal driving DCDC circuit unit can be corrected (changed) in any manner so that the input voltage can be maintained (the operation at the maximum power point of the solar panel) when the output voltage of DCDC circuit unit changes, the same effect can be obtained by applying various DCDC circuit units having other properties, not limited to the above-described modification.

### Application Example

This solar power generation control is described on the assumption that a system adopting a configuration in which three or more power generation systems in which a decrease in power generation efficiency appears remarkably are connected in parallel is adopted. However, in the following case, for example, it is possible to exert an effect even in a system in which two power generation systems (the first power generation system 11 and the second power generation system 12) are connected in parallel.

For example, consider where an ECU implementing solar power generation control (e.g., a solar control ECU 100) is functionally integrated with other ECU to cause a single processor on ECU to process solar power generation control and other functions. Here, it is assumed that MPPT control of the first power generation system 11, MPPT control of the second power generation system 12, and the processes other than the solar power generation control can be executed only sequentially. In this case, the operating point of the solar panel cannot be corrected during processing other than the solar power generation control. Therefore, in such a case, the effect of reducing the decrease in the power generation efficiency by correcting the duty ratio of the present disclosure can be expected.

Although an embodiment of the present disclosure has been described above, the present disclosure can be regarded as a solar power generation control method executed by a solar power generation system, a program of the method, a computer-readable non-transitory recording medium storing the program, a vehicle equipped with a solar power generation system, and the like, in addition to the solar power generation system.

The present disclosure is applicable to a solar power generation system in which a plurality of power generation systems including a solar panel and a DCDC circuit unit are connected in parallel.

What is claimed is:

1. A solar power generation system including a plurality of power generation systems connected in parallel, the power generation systems each including a solar panel and a direct current-to-direct current circuit unit configured to control an operating point of power generation of the solar panel according to a duty cycle of a drive signal of a direct current-to-direct current converter, the solar power generation system comprising:
a first control unit configured to perform maximum power point tracking control for a host power generation system that is one of the power generation systems, and drive the direct current-to-direct current circuit unit at the duty cycle corresponding to a maximum power point of the solar panel; and
a second control unit configured to, for each of slave power generation systems other than the host power generation system among the power generation systems, derive a variation ratio of an input voltage or an output voltage of the direct current-to-direct current circuit unit before and after the maximum power point tracking control is performed by the first control unit, and correct the duty cycle of the direct current-to-direct current circuit unit based on the variation ratio.

2. The solar power generation system according to claim 1, wherein the first control unit is configured to perform the maximum power point tracking control while sequentially switching each of the power generation systems to the host power generation system.

3. The solar power generation system according to claim 1, wherein the second control unit is configured to, when the variation ratio is a variation proportion of the input voltage after the maximum power point tracking control is performed to the input voltage before the maximum power point tracking control is performed, perform correction by multiplying the duty cycle by the variation proportion.

4. The solar power generation system according to claim 1, wherein the second control unit is configured to, when the variation ratio is a variation proportion of the output voltage after the maximum power point tracking control is performed to the output voltage before the maximum power point tracking control is performed, perform correction by dividing the duty cycle by the variation proportion.
